(19) United States
(12) Patent Application Publication
(10) Pub. No.: US 2016/0287466 A1
(43) Pub. Date: Oct. 6, 2016

(54) MUSCULOSKELETAL INSTRUMENT

(71) Applicant: Rodney Joseph Bampton, Wentzville, MO (US)

(72) Inventor: Rodney Joseph Bampton, Wentzville, MO (US)

(21) Appl. No.: 14/675,314

(22) Filed: Mar. 31, 2015

(51) Int. Cl. A61H 7/00

(52) U.S. Cl. CPC A61H 7/003

(57) ABSTRACT

A musculoskeletal instrument with a plurality of fluid relief channels is provided. The instrument includes a substantially flat body that has an outer rim. The outer rim forms a first concave portion and a second concave portion. The first concave portion includes a greater radius of curvature than the second concave portion. Therefore, the present invention may be used for different treatment areas. Each of the first concave portion and the second concave portion include a plurality of teeth formed on the outer rim by a plurality of channels. The plurality of teeth and the substantially flat body are planar.

### BACKGROUND OF THE INVENTION

The present invention relates to treatment of Tendonopathy and, more particularly, to treatment of Tendonopathy with a musculoskeletal instrument.

To treat tissue damage and pain associated with soft tissue treatment, instruments are use to rub against the inflamed area. Current instruments have solid surfaces and edges which creates a high level of drag on the tissue surface. The flat constant edge causes a higher amount of friction and a greater contact surface. Therefore, in order to treat the underlying tissue, a greater amount of force and increased application is needed for an acceptable result. As can be seen, there is a need for an improved musculoskeletal instrument.

### SUMMARY OF THE INVENTION

In one aspect of the present invention, a musculoskeletal instrument comprises: a substantially flat body comprising an outer rim, wherein the outer rim forms a first concave portion and a second concave portion, wherein the first concave portion comprises a greater radius of curvature than the second concave portion, wherein each of the first concave portion and the second concave portion comprises a plurality of teeth formed on the outer rim by a plurality of channels, wherein the plurality of teeth and the substantially flat body are planar.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a front perspective view of an embodiment of the present invention;

FIG. 3 is a rear perspective view of an embodiment of the present invention;

FIG. 4 is a detail perspective view of an embodiment of the present invention;

FIG. 5 is a section view of the present invention, taken along line 5-5 in FIG. 2;

FIG. 6 is a section view of the present invention, taken along line 6-6 in FIG. 5; and

FIG. 7 is a section view of the present invention, taken along line 7-7 in

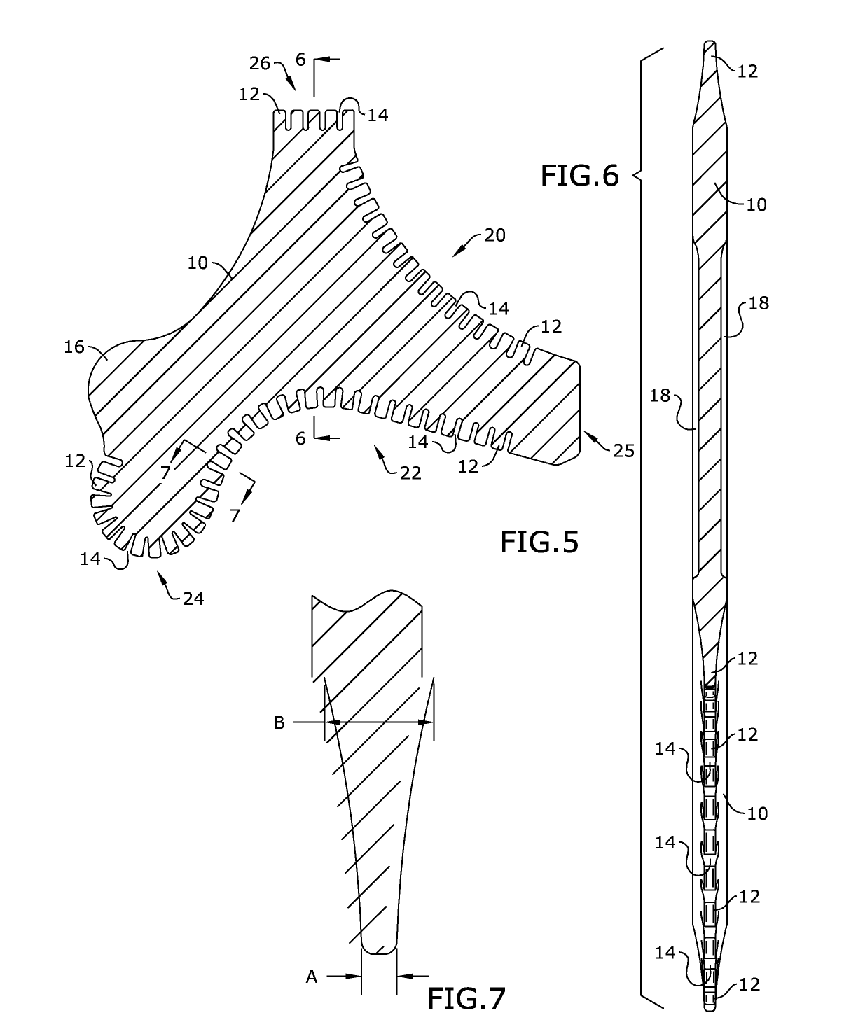

FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a musculoskeletal instrument with fluid relief channels built in to reduce pressure during treatment. The shape of the device is also particular as it has many shaped surfaces and processes to fit many different parts of the body. By reducing the surface area contacting the skin and providing channels in the treatment surface, the treatment can be delivered with less force and thus decreasing pain and discomfort.

In certain embodiments, the present invention may include a three prong shape modeled after an animal in nature, which provides leverage on the instrument no matter the edge being used. This allows the user to use the instrument on many patients without being tired. The fluid relief channels allow the instrument to glide through the swelling and inflammation without causing more damage to the injury or the tissue overlying the injury. The asymmetric shapes, having no two sides match, allow the instrument to treat any area of the body without changing the instrument. Further, the concavity of the sides reduce the friction by having the teeth slightly behind the lead tooth thus reducing drag and allowing less pressure to be used and a reduction in damage of soft tissue related to treatment. The shape of each tooth may be designed to reduce skin drag and irritation.

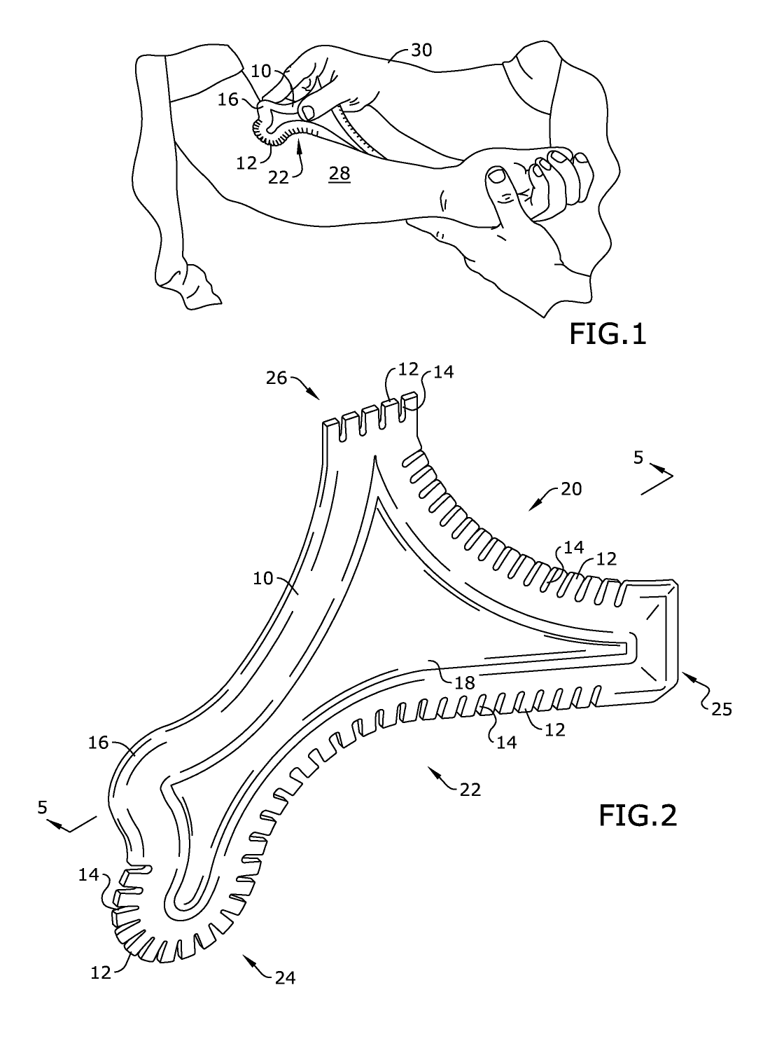

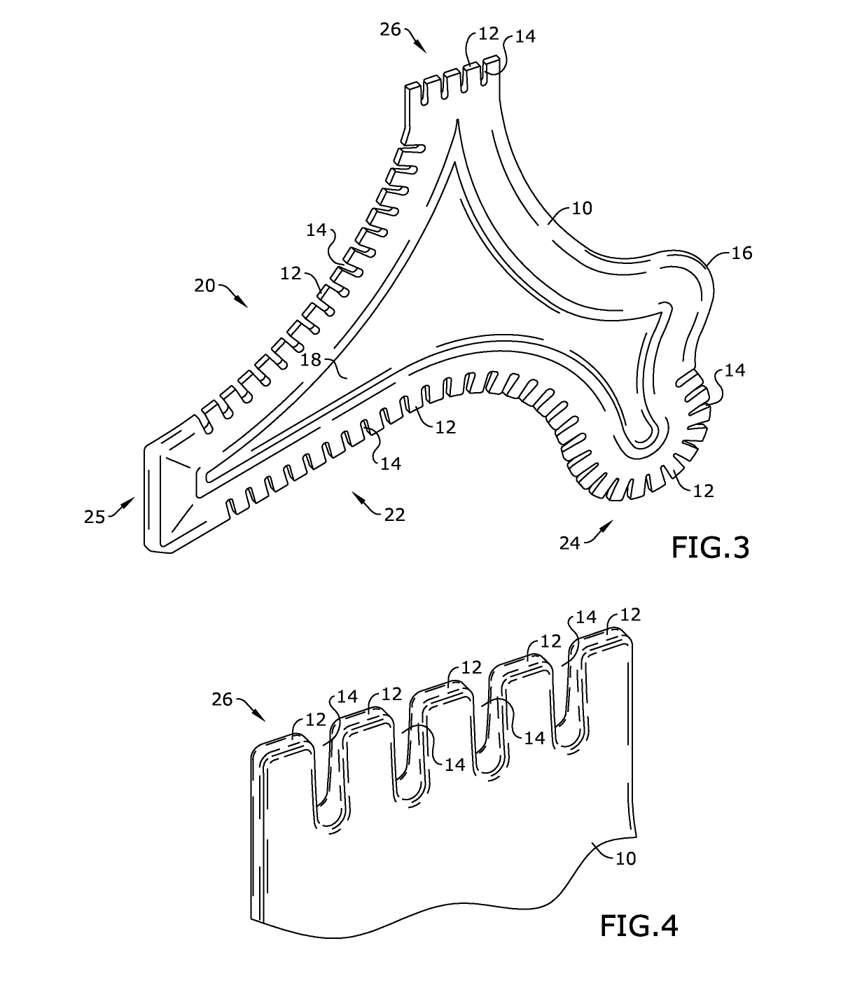

Referring to FIGS. 1 through 7, the present invention includes a musculoskeletal instrument having a body 10. The body 10 is substantially flat and has an outer rim. The outer rim forms a first concave portion 20 and a second concave portion 22. The first concave portion 20 includes a greater radius of curvature than the second concave portion 22. Therefore, the present invention may be used for different treatment areas 28. Each of the first concave portion 20 and the second concave portion 22 include a plurality of teeth 12 formed on the outer rim by a plurality of channels 14. The plurality of channels 14 are the fluid relief channels mentioned above. The plurality of teeth 12 and the substantially flat body 10 are planar.

In certain embodiments, the body 10 is in a triangular shape, similar to a fin. In such embodiments, the first concave portion 20 is on a first side of the triangular shape, the second concave portion 22 is on a second side of the triangular shape, and a grip 16 is on a third side of the triangular shape. The grip 16 allows the user 30 to securely hold the body 10 while applying the channeled edges to the treatment area 28. In certain embodiments, the grip 16 may include a convex portion and a concave portion. In certain embodiments, the present invention may include a recess 18 formed on at least one of an upper surface and a lower surface. The recess 18 aids in the grip 16 of the present invention. The triangular shaped body 10 includes a first corner portion 26 where the handle portion 16 and the first concave portion meet 20, a second corner portion 25 where the first concave portion 20 and the second concave portion 22 meet, and a third corner portion 24 where the second concave portion 22 and the handle 16 meet. The first corner portion 26 may be substantially flat and include a plurality of teeth 12 formed on the outer rim by a plurality of channels 14. The second corner portion 25 may be substantially flat. The third corner portion 24 may include a convex shape and a plurality of teeth 12 formed on the outer rim by a plurality of channels 14. The teeth 14 may extend radially from the third corner portion 24.

As illustrated in FIG. 7, each of the teeth 12 may taper from the body 10 to a tip. Further, the plurality of teeth 12 may each include a rounded tip. The shape of each tooth 12 has been designed to reduce skin drag and irritation. The radii of the edges of the teeth 12 have been carefully tested and the best dimensions have been chosen. The incorrect radii have a tendency to scrape the patient and cause injury and pain.

The present invention works by magnifying the issues within the tissues, including scars, restrictions, and adhesions. The present invention is effective because it creates a controlled micro-trauma to soft tissues. The present invention triggers a localized inflammatory healing reaction and increases cellular activity. This response stimulates an appropriate, more functional, and less painful healing of the injured tissues. The teeth focus the force through an area that is smaller than a finger, which allows for more efficient treatment with less force applied. A practitioner's touch alone is not sensitive enough to perceive restrictions at deep levels or treat the full range of restrictions.

A sore muscle is an indication of what needs to be treated. To determine the injured area simply touch each muscle from where it starts at the joint and work out into the muscle belly. Start at the origin and move into the belly. The origin of the muscle is the point at which it attaches to a bone, and the insertion is the end of the muscle attaching to the freely moving bone of that joint.

With a washable marker, the user may touch the tender area with their finger and mark that spot. Then from there, apply pressure up from that spot until the tissue becomes no longer tender, mark that spot and palpate down from the original spot until the muscle becomes non tender. The injured area is now outlined. These palpations running parallel with the muscle usually indicates that the pain is in a single muscle. Now from the original mark, move to the left in half inch increments. If the tenderness continues to the left and later to the right, these muscles are then palpated up and down to find the margins of those injured muscles. This method of treatment is the easiest way to find all of the injured muscles and will make it easier to treat. The present invention is used to treat the muscle along its length.

There may only be twelve strokes on any one muscle per treatment. Lotion may be used on the muscle to reduce friction between the skin and the present invention. The muscle may be worked on with an active range of motion. This is done by shortening the muscle, contacting the intended muscle with the present invention, and actively lengthening the muscle again while applying pressure. The present invention may be held at about a 15 to 30 degree angle. Apply enough pressure to feel the texture of the scar tissue under the skin. The treatment can be performed on a daily basis.

After treatment the muscles may feel sore or tender to the touch. Bruising may also occur after treatment but is a normal response by the body. If proper force is applied bruising should be minimal. If bruising does occur use less force. Also be aware that the areas being treated are usually hypersensitive to touch, so the pressure being used is going to feel more painful.

It should be understood, of course, that the foregoing relates to exemplary embodiments of the invention and that modifications may be made without departing from the spirit and scope of the invention as set forth in the following claims.

What is claimed is:

1. A musculoskeletal instrument comprising:
a substantially flat body comprising an outer rim,
wherein the outer rim forms a first concave portion and a second concave portion,
wherein the first concave portion comprises a greater radius of curvature than the second concave portion,
wherein each of the first concave portion and the second concave portion comprises a plurality of teeth formed on the outer rim by a plurality of channels,
wherein the plurality of teeth and the substantially flat body are planar.

2. The musculoskeletal instrument of claim 1, wherein the substantially flat body comprises a triangular shape, wherein the first concave portion comprises a first side of the triangular shape, the second concave portion comprises a second side of the triangular shape, and a grip comprises a third side of the triangular shape.

3. The musculoskeletal instrument of claim of claim 2, wherein the grip comprises a convex portion and a concave portion.

4. The musculoskeletal instrument of claim 2, wherein the triangular shape comprises a first corner portion where the handle portion and the first concave portion meet, a second corner portion where the first concave portion and the second concave portion meet, and a third corner portion where the second concave portion and the handle meet.

5. The musculoskeletal instrument of claim 4, wherein the first corner portion is substantially flat and comprises a plurality of teeth formed on the outer rim by a plurality of channels.

6. The musculoskeletal instrument of claim 4, wherein the second corner portion is substantially flat.

7. The musculoskeletal instrument of claim 4, wherein the third corner portion is a convex shape and comprises a plurality of teeth formed on the outer rim by a plurality of channels.

8. The musculoskeletal instrument of claim 1, wherein each of the plurality of teeth taper from the body to a tip.

9. The musculoskeletal instrument of claim 1, wherein each of the plurality of teeth comprise a rounded tip.

10. The musculoskeletal instrument of claim 1, wherein the substantially flat body comprises a recess formed on at least one of an upper surface and a lower surface.
